(19) United States
(12) Patent Application Publication
(10) Pub. No.: US 2025/0154377 A1
(43) Pub. Date: May 15, 2025

(54) HIGH-RELIABILITY FAST-CURING UV GLUE FOR OUTER LAYER PROTECTION OF POWER BATTERY, AND PREPARATION METHOD AND APPLICATION THEREOF

(71) Applicant: WELDTONE TECHNOLOGY CO., LTD., Fujian (CN)

(72) Inventors: Haitao WANG, Fujian (CN); Changjing CHEN, Fujian (CN)

(73) Assignee: WELDTONE TECHNOLOGY CO., LTD., Fujian (CN)

(21) Appl. No.: 19/026,648

(22) Filed: Jan. 17, 2025

Related U.S. Application Data
(63) Continuation of application No. PCT/CN2024/109151, filed on Aug. 1, 2024.

(30) Foreign Application Priority Data
Oct. 19, 2023 (CN) 202311355895.6

(51) Int. Cl. C09J 4/06; C09J 11/06; C09J 133/08; H01M 50/119; H01M 50/124

(52) U.S. Cl. CPC C09J 4/06; C09J 11/06; C09J 133/08; H01M 50/1245; H01M 50/119

(57) ABSTRACT

The present disclosure belongs to the field of UV glues, and refers to a high-reliability fast-curing UV glue for outer layer protection of a power battery, and a preparation method and application thereof. The high-reliability fast-curing UV glue contains an acrylate oligomer, a monofunctional acrylate monomer, a difunctional acrylate monomer, a trifunctional acrylate monomer, an acidic functional group-containing acrylate monomer, a photoinitiator and an optional auxiliary agent, where the acrylate oligomer simultaneously contains a dibasic acid-modified bisphenol A epoxy acrylate, a tetrafunctional branched polyester acrylate and a polyurethane acrylate with the polyester diol as a main chain.

### CROSS-REFERENCE TO RELATED APPLICATION

The present application is a continuation application of international PCT application serial no. PCT/CN2024/109151, filed on Aug. 1, 2024, which claims the priority of the Chinese patent application No. 202311355895.6, filed with China National Intellectual Property Administration on Oct. 19, 2023, and entitled “HIGH-RELIABILITY FAST-CURING UV GLUE FOR OUTER LAYER PROTECTION OF POWER BATTERY, AND PREPARATION METHOD AND APPLICATION THEREOF”, which is incorporated in its entirety herein by reference.

### TECHNICAL FIELD

The present disclosure belongs to the field of UV glues, and in particular relates to a high-reliability fast-curing UV glue for outer layer protection of a power battery, and a preparation method and application thereof.

### BACKGROUND

Since the new energy vehicle industry has become the focus of people's attention, reforms and innovations have been successively carried out in its related individual technical fields. On the basis of improving the ultimate performance, it has begun to pay attention to high efficiency, environmental protection, energy conservation and emission reduction. The packaging and integration of power batteries are crucial links. On the premise of meeting their industrial production, they are required to have promotional values in respect to high production efficiency, excellent yield, low cost, safety and reliability, and good volume utilization. Excellent insulation protection in the outer packaging of power batteries can improve the safety and reliability of the batteries, thereby reducing the risk of electric leakage caused by external corrosion. At the same time, it can also improve volume utilization to leave room for subsequent battery integration upgrades, and help designers achieve the goal of lightweight batteries. The traditional outer packaging protection of a battery cell is mainly achieved by wrapping with a PET blue film, and the blue film is bonded with an aluminum layer of the battery cell through glue. This manner has complex processes, low production efficiency, and high energy consumption. It does not meet the requirements of energy saving, high efficiency, and green environmental protection. In addition, due to the limitations of glue performance and construction processes, it is impossible to always ensure the complete fit between the blue film and the aluminum layer of the battery cell, which can easily cause hollowing bulges and air bubbles, and has a high risk of failure, limiting the development of lightweight batteries.

Considering the quality reliability, energy-saving and high efficiency of actual terminal utilization, an improved packaging protection solution at this stage is an inkjet process. In the inkjet process, an UV glue is sprayed to cover an outer layer of a cell, and then cured with a UV light source to obtain an insulating protective layer, which replaces the PET blue film as the outer protective layer of the cell, leaving sufficient design space for the lightweight development of batteries. According to the inkjet process and the usage performance, the UV glue needs to meet basic characteristics of bonding strength requirements and reliability requirements such as insulation and voltage resistance, water-boiling resistance, salt spray resistance etc., while also needs to ensure that the UV glue can be cured quickly. However, due to the limited viscosity of the UV glue in the existing process, the quality of a product sprayed by atomization is unstable, the utilization rate of the glue is low, and it is very easy to cause waste. Meanwhile, the curing speed of the glue is general and cannot adapt to a more energy-saving and efficient LED curing process. Moreover, due to the limitations of formula performance, the bonding strength and reliability of the UV glue are poor, and the results of aging tests such as tests for water-boiling resistance and salt spray resistance of it are not ideal, which cannot meet the increasingly stringent market requirements. Therefore, it has become an urgent problem to obtain a UV glue for outer layer protection of power batteries, which has both high reliability of insulation and voltage resistance, water-boiling resistance, salt spray resistance, etc., and high bonding strength and can be cured quickly.

### SUMMARY

An objective of the present disclosure is to overcome the defects of the existing UV glue for outer layer protection of a power battery, such as poor reliability of insulation and voltage resistance, water-boiling resistance, salt spray resistance, etc., poor bonding strength and a general curing speed, by providing a UV glue that has both high reliability of insulation and voltage resistance, water-boiling resistance, salt spray resistance, etc. and high bonding strength and can be cured quickly, and a preparation method thereof, as well as application thereof in insulation protection of outer packaging of a power battery cell.

After in-depth study, the inventor of the present disclosure has found that an insulation protective layer of UV glue having a skeletal structure constructed from three prepolymers of a dibasic acid modified bisphenol A epoxy acrylate, a tetrafunctional branched polyester acrylate and a polyurethane acrylate with polyether diol as a main chain, has both high reliability of insulation and voltage resistance, water-boiling resistance, salt spray resistance, etc. and high bonding strength, and can be cured quickly. It is supposed that the reason may be due to the follows. A main chain segment of the dibasic acid-modified bisphenol A epoxy acrylate contains benzene ring structure, which constitute a rigid part of the skeletal structure of the insulation protection layer formed by UV glue, thereby endowing the UV glue with excellent hardness, tensile strength, high-temperature resistance and aging resistance. The dibasic acid-modified bisphenol A epoxy acrylate has a relatively longer chain length, and such a specific structure can reduce the volume shrinkage and internal stress of curing, thereby improving its bonding effect on the aluminum layer of the cell. Due to the low polarity characteristic of the dibasic acid fatty chain structure in the dibasic acid-modified bisphenol A epoxy acrylate, the hydrophobicity of the insulation protection layer is enhanced, ensuring that the cured insulation protective layer of UV glue has reliability of water-boiling resistance, salt spray resistance, etc. Moreover, an ether bond structure is introduced through the ring-opening reaction of the dibasic acid-modified bisphenol A epoxy acrylate to reduce a molecular internal rotation barrier potential, thereby reducing the viscosity and increasing the glue yield to adapt to an inkjet process. With the increase of the concentration of acrylic double-bond functional groups in the tetrafunctional branched polyester acrylate, the activity of the photocuring reaction is significantly increased, which significantly improves the overall photocuring speed of the UV glue, so as to realize a LED curing process. Moreover, the curing of the tetrafunctional oligomer forms a three-dimensional network cross-linked structure. Such a dense structure can effectively improve the water-blocking, wear-resistant, and the like properties of the glue layer. Meanwhile, due to the high content of polar ester bonds, it has good wetting and dispersion effects on pigments, and also improves the interface bonding force between the UV glue and the aluminum material of the cell. The polyurethane acrylate with polyester diol as the main chain has low viscosity and good flexibility after curing, and is a flexible part in the skeletal structure of the insulating protective layer. The urethane bond in its main chain structure can form hydrogen bonds between molecules, which has the effects of reducing the shrinkage stress of curing and improving its adhesion to the aluminum material of the cell. Meanwhile, it also makes the glue layer have buffering properties, ensuring the overall toughness of the glue layer, which can increase the bending and impact resistant effects, and effectively improve the insulation and voltage resistance performance.

After in-depth study, the inventor of the present disclosure has also found that when a specific ratio of a monofunctional acrylate monomer, a difunctional acrylate monomer, a trifunctional acrylate monomer and an acidic functional group-containing acrylate monomer are simultaneously introduced into the UV glue, the resulting UV glue has more excellent performance. It is supposed that the reason may be due to the follows. If a benzene ring is introduced into the monofunctional acrylate monomer, it can form a conjugated system with an acrylate double bond, so that the acrylate double bond is activated, the reaction activity is enhanced, and quick curing can be achieved even with low illumination energy, which adapts to the more energy-saving and efficient LED curing. If a three-dimensional ring structure of a bridge or a bicyclic diene group is introduced into the monofunctional acrylate monomer, the steric hindrance can be increased, and the water-blocking, water-proofing, and insulation and voltage resistance properties of the UV glue layer can be improved. The difunctional acrylate monomer can increase the density of the glue layer, and improve the hardness and wear resistance of the glue layer. The trifunctional acrylate monomer uses three reactive groups as cross-linking points to connect respective acrylate oligomers and acrylate monomers, so that the system forms a dense and stable three-dimensional network structure, thereby further enhancing the water-blocking and wear resistance properties of the UV glue. The acidic group in the middle section of the acidic functional group-containing acrylate monomer can improve the adhesion of the glue layer to the aluminum layer of the cell, thereby enhancing the bonding strength of the UV glue.

In view of the above, the three prepolymers, i.e., the dibasic acid-modified bisphenol A epoxy acrylate, the tetrafunctional branched polyester acrylate and the polyurethane acrylate with polyester diol as the main chain, are compounded and used, and meanwhile a specific proportion of the monofunctional acrylate monomer, the difunctional acrylate monomer, the trifunctional acrylate monomer and the acidic functional group-containing acrylate monomer are introduced to prepare the high-reliability fast-curing UV glue, which can endow the glue layer with the good reliability of insulation and voltage resistance, water-boiling resistance, salt spray resistance, etc. as well as the high bonding strength and the quick curing properties. Based on this, the present disclosure is completed.

Specifically, the present disclosure provides a high-reliability fast-curing UV glue containing an acrylate oligomer, a monofunctional acrylate monomer, a difunctional acrylate monomer, a trifunctional acrylate monomer, an acidic functional group-containing acrylate monomer, a photoinitiator and an optional auxiliary agent, wherein the acrylate oligomer simultaneously contains a dibasic acid-modified bisphenol A epoxy acrylate, a tetrafunctional branched polyester acrylate and a polyurethane acrylate with the polyester diol as a main chain.

In a preferred embodiment, in percentage by weight, the content of the acrylate oligomer is 20-50%, the content of the monofunctional acrylate monomer is 30-55%, the content of the difunctional acrylate monomer is 5-15%, the content of the trifunctional acrylate monomer is 3-10%, the content of the acidic functional group-containing acrylate monomer is 0.5-5%, the content of the photoinitiator is 5-12%, the content of the auxiliary agent is 0.02-2%.

In a preferred embodiment, a mass ratio of the dibasic acid-modified bisphenol A epoxy acrylate, the tetrafunctional branched polyester acrylate and the polyurethane acrylate with the polyester diol as the main chain in the acrylate oligomer is 1:(0.3-0.9): (0.2-0.6).

In a preferred embodiment, the dibasic acid-modified bisphenol A epoxy acrylate has a structure as shown in formula (I):

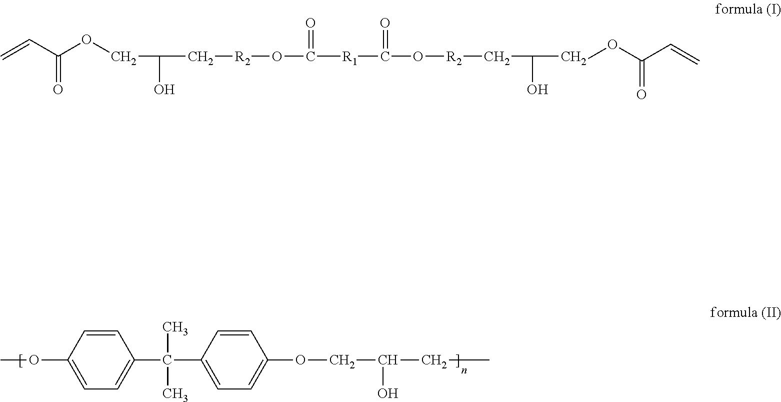

in the formula (I), R₁ is selected from one of C₁-C₁₀ alkylene groups, R₂ has a structure as shown in formula (II), and n is 1-10.

In a preferred embodiment, the dibasic acid-modified bisphenol A epoxy acrylate is prepared according to the following method: subjecting a bisphenol A epoxy resin, acrylic acid and an aliphatic dibasic acid to a ring-opening reaction to obtain a dibasic acid-modified bisphenol A epoxy acrylate which has a structure as shown in formula (I).

In a preferred embodiment, a general formula of the aliphatic dibasic acid is HOOC—R₁—COOH, wherein R₁ is selected from one of C₁-C₁₀ alkylene groups.

In a preferred embodiment, a molar ratio of the bisphenol A epoxy resin to the acrylic acid is 1:(0.8-1).

In a preferred embodiment, a molar ratio of the bisphenol A epoxy resin to the aliphatic dibasic acid is 1:(0.35-0.55).

In a preferred embodiment, a condition for the ring-opening reaction comprises a temperature of 90-120° C. and a time of 1-10 h.

In a preferred embodiment, the tetrafunctional branched polyester acrylate has a main chain structure as shown in formula (III) and four acrylate functional group structures as shown in formula (III′):

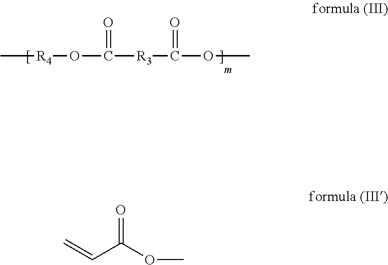

in the formula (III), R₃ and R₄ are each independently selected from one of substituted or unsubstituted C₁-C₁₀ alkylene groups, and m is 1-10.

In a preferred embodiment, the polyurethane acrylate with the polyester diol as the main chain has a structure as shown in formula (IV):

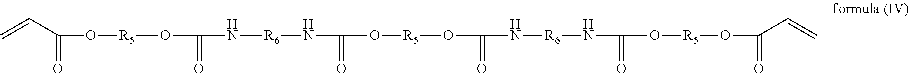

in the formula (IV), R₅ and R₆ are each independently selected from one of C₁-C₁₀ alkylene groups.

In a preferred embodiment, the monofunctional acrylate monomer simultaneously contains a acrylate monomer containing benzene ring, a acrylate monomer containing bridge group and a acrylate monomer containing bicyclic diene group.

In a preferred embodiment, the acrylate monomer containing benzene ring is at least one selected from 2-phenoxyethyl acrylate, 4-ethylphenyl acrylate, 3,5-dihydroxyphenol methacrylate and benzyl acrylate

In a preferred embodiment, the acrylate monomer containing bridge group is at least one selected from isobornyl acrylate, 3-isobornylcyclohexyl acrylate and isobornyl methacrylate.

In a preferred embodiment, the acrylate monomer containing bicyclic diene group is at least one selected from dicyclopentenyl acrylate, dicyclopentenyl ethoxylated acrylate and dicyclopentenyl methacrylate.

In a preferred embodiment, the difunctional acrylate monomer is at least one selected from tricyclodecane dimethanol diacrylate, 1,6-hexanediol diacrylate, dipropylene glycol diacrylate and ethoxylated bisphenol A diacrylate.

In a preferred embodiment, the trifunctional acrylate monomer is at least one selected from ethoxylated trimethylolpropane triacrylate, trimethylolpropane triacrylate and tris (2-hydroxy ethyl) isocyanurate triacrylate.

In a preferred embodiment, the acidic functional group-containing acrylate monomer is a phosphate acrylate and/or a carboxylic acid group-containing acrylate

In a preferred embodiment, the photoinitiator is a combination of 2,4,6-trimethylbenzoyl diphenylphosphine oxide, 2-methyl-2-(4-morpholinyl)-4′-(methylthio) propiophenone and 2-isopropylthioxanthone.

In a preferred embodiment, a mass ratio of the 2-methyl-2-(4-morpholinyl)-4′-(methylthio) propiophenone to the 2-isopropylthioxanthone is (2-4):1.

In a preferred embodiment, a mass ratio of the 2,4,6-trimethylbenzoyl diphenylphosphine oxide to the 2-isopropylthioxanthone is (8-18):1.

In a preferred embodiment, the auxiliary agent is at least one selected from a pigment, a leveling agent, a dispersant, an abrasive agent and a diluent.

The present disclosure provides a method for preparing the high-reliability fast-curing UV glue. The method includes uniformly mixing an acrylate oligomer, a monofunctional acrylate monomer, a difunctional acrylate monomer, a trifunctional acrylate monomer, an acidic functional group-containing acrylate monomer, a photoinitiator and an optional auxiliary agent to obtain a high-reliability fast-curing UV glue.

In a preferred embodiment, the mixing manner includes the following steps:
S1. uniformly mixing a trifunctional acrylate monomer, a pigment and a dispersant to obtain a color paste premix;
S2. uniformly mixing a monofunctional acrylate monomer, a difunctional acrylate monomer, a trifunctional acrylate monomer, an acidic functional group-containing acrylate monomer, a photoinitiator and a leveling agent to obtain a pretreated material; and
S3. uniformly mixing the color paste premix obtained in S1, the pretreated material obtained in S2, and an acrylate oligomer to obtain the high-reliability fast-curing UV glue.

Moreover, the present disclosure also provides application of the high-reliability fast-curing UV glue in the insulation protection of the outer packaging of power battery cells.

The high-reliability fast-curing UV glue provided by the present disclosure has low viscosity and good fluidity, and is suitable for inkjet processes with high precision and a high utilization rate. It has a quick curing speed, and can be cured even with long-wave light band, and also takes into account both surface drying and deep curing, thus it is suitable for energy-saving and efficient LED curing processes. The cured glue layer has high hardness and is resistant to bending, reducing the influence of external-force damage on the cell. The glue layer has good insulation and voltage resistance, and is not easily broken down by voltage, so as to has an obvious leakage current blocking protection effect on the cell. The glue layer has dense cross-linking and a stable molecular structure, and can still maintain an excellent insulation protection effect after aging tests such as a water-boiling test and a salt spray test. Compared with the protection by a traditional PET blue film, the protection by the high-reliability fast-curing UV glue provided by the present disclosure has the simplified process and avoids process defects caused by lamination, and also improves the bonding strength and the reliability of insulation and voltage resistance, water-boiling resistance, salt spray resistance and the like of the UV glue used for the high-precision inkjet process. In view of the above, the UV glue provided by the present application has low viscosity and a quick curing speed. It can more adapt to energy-saving and efficient LED curing and adapt to a high-precision inkjet process, while meeting the reliability requirements of insulation and voltage resistance, water-boiling resistance, and salt spray resistance and the bonding strength requirements. It can replace the PET blue film as the insulating protective layer of the outer packaging of power batteries, reserving sufficient design space for lightweight batteries.

### DETAILED DESCRIPTION OF THE EMBODIMENTS

The technical solution of the present disclosure is further illustrated and described hereafter through specific embodiments.

The high-reliability fast-curing UV glue provided by the present disclosure contains an acrylate oligomer, a monofunctional acrylate monomer, a difunctional acrylate monomer, a trifunctional acrylate monomer, an acidic functional group-containing acrylate monomer, a photoinitiator, and an optional auxiliary agent. In percentage by weight, the content of the acrylate oligomer is 20-50%, e.g. 20%, 25%, 30%, 35%, 40%, 45%, 50% or any value therebetween; the content of the monofunctional acrylate monomer is 30-55%, e.g. 30%, 35%, 40%, 45%, 50%, 55% or any value therebetween; the content of the difunctional acrylate monomer is 5-15%, e.g. 5%, 7%, 9%, 11%, 13%, 15% or any value therebetween; the content of the trifunctional acrylate monomer is 3-10%, e.g. 3%, 4%, 5%, 6%, 7%, 8%, 9%, 10% or any value therebetween; the content of the acidic functional group-containing acrylate monomer is 0.5-5%, e.g. 0.5%, 1%, 1.5%, 2%, 2.5%, 3%, 3.5%, 4%, 4.5%, 5% or any value therebetween; the content of the photoinitiator is 5-12%, e.g. 5%, 6%, 7%, 8%, 9%, 10%, 11%, 12% or any value therebetween;

and the content of the auxiliary agent is 0.02-2%, e.g. 0.02%, 0.2%, 0.5%, 1%, 1.5%, 2% or any value therebetween.

In the present disclosure, the acrylate oligomer simultaneously contains a dibasic acid-modified bisphenol A epoxy acrylate, a tetrafunctional branched polyester acrylate and a polyurethane acrylate with polyester diol as a main chain. A mass ratio of the dibasic acid-modified bisphenol A epoxy acrylate to the tetrafunctional branched polyester acrylate is preferably 1:(0.3-0.9), e.g. 1:0.3, 1:0.4, 1:0.5, 1:0.6, 1:0.7, 1:0.8, 1:0.9 or any value therebetween; and a mass ratio of the dibasic acid-modified bisphenol A epoxy acrylate to the polyurethane acrylate with polyester diol as the main chain is preferably 1:(0.2-0.6), e.g. 1:0.2, 1:0.3, 1:0.4, 1:0.5, 1:0.6 or any value therebetween.

In the present disclosure, the dibasic acid-modified bisphenol A epoxy acrylate preferably has a structure as shown in formula (I):

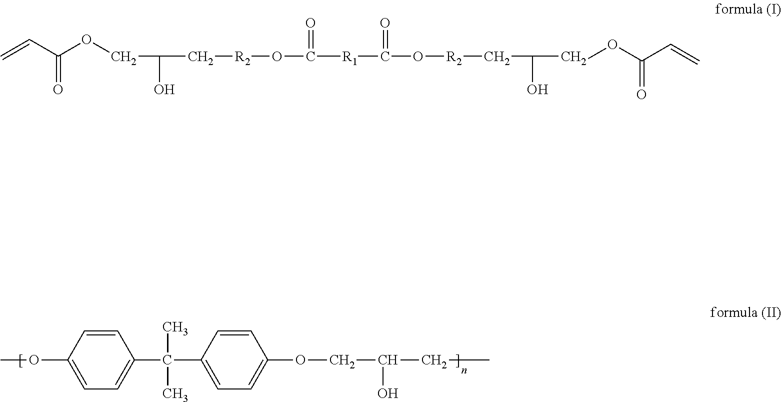

in the formula (I), R₁ is selected from one of C₁-C₁₀ alkylene groups, R₂ has a structure as shown in formula (II), and n is 1-10. The specific implementation of the C₁-C₁₀ alkylene group includes but is not limited to: methylene, ethylidene, propylidene, butylidene, pentylidene, hexylidene, heptylidene, octylidene or nonylidene.

In the present disclosure, the dibasic acid-modified bisphenol A epoxy acrylate can be commercially available, or prepared according to various methods well known in the art. In a preferred embodiment, the dibasic acid-modified bisphenol A epoxy acrylate is preferably prepared according to the following method: subjecting a bisphenol A epoxy resin, acrylic acid and an aliphatic dibasic acid to a ring-opening reaction to obtain a dibasic acid-modified bisphenol A epoxy acrylate which has a structure as shown in formula (I). A molar ratio of the bisphenol A epoxy resin to acrylic acid is preferably 1:(0.8-1), e.g. 1:0.8, 1:0.85, 1:0.9, 1:0.95, 1:1 or any value therebetween. A molar ratio of the bisphenol A epoxy resin to the aliphatic dibasic acid is preferably 1:(0.35-0.55), e.g. 1:0.35, 1:0.4, 1:0.45, 1:0.5, 1:0.55 or any value therebetween. The condition for the ring-opening reaction includes a temperature of preferably 90-120° C., e.g. 90° C., 95° C., 100° C., 105° C., 110° C., 115° C., 120° C. or any value therebetween; and a time of 1-10 h, e.g. 1h, 2 h, 4 h, 6 h, 8 h, 10 h or any value therebetween. The present disclosure has no particular limitation on the type of aliphatic dibasic acid, as long as it can form an ether bond structure by the ring-opening reaction with the bisphenol A epoxy resin. A general formula of the aliphatic dibasic acid is HOOC—R₁—COOH, where R₁ is selected from one of C₁-C₁₀ alkylene groups. The specific example of the C₁-C₁₀ alkylene group includes, but is not limited to: at least one of glutaric acid, adipic acid, pimelic acid, suberic acid and azelaic acid.

In the present disclosure, the tetrafunctional branched polyester acrylate preferably has a main chain structure as shown in formula (III) and four acrylate functional group structures as shown in formula (III′):

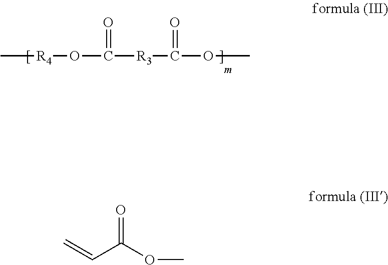

in the formula (III), R₃ and R₄ are each independently selected from one of substituted or unsubstituted C₁-C₁₀ alkylene groups, and m is 1-10. The acrylate functional group structures may be all located at the end groups of the tetrafunctional branched polyester acrylate, or all located at the side groups of the tetrafunctional branched polyester acrylate, or partially located at the end groups and partially located at the side groups. The specific implementation of the C₁-C₁₀ alkylene group includes but is not limited to: methylene, ethylidene, propylidene, butylidene, pentylidene, hexylidene, heptylidene, octylidene or nonylidene. m may be 1, 2, 3, 4, 5, 6, 7, 8, 9 or 10.

In the present disclosure, the tetrafunctional branched polyester acrylate can be prepared by various existing methods or can be commercially available, e.g., at least one of 6320 of Changxing Chemical Industry (China) Co., Ltd. (referred to as Changxing for short), EBECRYL 657 and EBECRYL 800 of Allnex Resins (China) Co., Ltd., and GU9400Y and GU9600Z of Qualipoly Chemical Corporation.

In the present disclosure, the polyurethane acrylate with polyester diol as the main chain has a structure as shown in formula (IV):

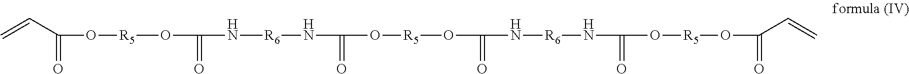

in the formula (IV), R₅ and R₆ are each independently selected from one of C₁-C₁₀ alkylene groups.

The specific implementation of the C₁-C₁₀ alkylene group includes, but is not limited to: methylene, ethylidene, propylidene, butylidene, pentylidene, hexylidene, heptylidene, octylidene or nonylidene.

In the present disclosure, the polyurethane acrylate with polyester diol as the main chain can be prepared by various existing methods, or can be commercially available, such as Y-5656 (having the structure as shown in formula (IV)) available from Shanghai Yinzhu Industrial Co., Ltd. (hereinafter referred to as Yinzhu for short).

In the present disclosure, the monofunctional acrylate monomer simultaneously includes a acrylate monomer containing benzene ring, a acrylate monomer containing bridge group and a acrylate monomer containing bicyclic diene group. Specific examples of the acrylate monomer containing benzene ring include, but are not limited to: at least one of 2-phenoxyethyl acrylate, 4-ethylphenyl acrylate, 3,5-dihydroxyphenol methacrylate and benzyl acrylate. Specific examples of the acrylate monomer containing bridge group include, but are not limited to: at least one of isobornyl acrylate, 3-isobornylcyclohexyl acrylate and isobornyl methacrylate. Specific examples of the acrylate monomer include containing bicyclic diene group, but are not limited to: at least one of dicyclopentenyl acrylate, dicyclopentenyl ethoxylated acrylate and dicyclopentenyl methacrylate. Among monofunctional acrylate monomers, the acrylate monomer containing benzene ring has low viscosity and strong dilution ability. Due to the special structure of the benzene ring-containing acrylate monomer, the benzene ring forms a conjugated system with the acrylate double bond, and the electron delocalization is strong. So that the acrylate double bond is activated, and the reaction activity is very strong. In practical applications, the strong reaction activity is reflected in the characteristics of quick curing even with low illumination energy, which promotes the UV glue to adapt to LED curing and a high-precision inkjet process. Moreover, the bridge group-containing acrylate monomer and the bicyclic diene group-containing acrylate monomer have low polarity, and the three-dimensional ring structures of the bridge group and the bicyclic diene group have large steric hindrance, which is beneficial to improving the water-blocking, water-proofing, and insulation and voltage resistance properties of the UV glue layer. It can also reduce the curing volume shrinkage of the UV glue and reduce the internal stress caused by the curing shrinkage, thereby improving the adhesion of the UV glue to the outer layer of the aluminum material of the cell. And this structure brings considerable toughness and cushioning properties and improves the bending and impact resistance of the UV glue layer, so that when the cell is damaged by an external force, the glue layer will not lose its insulation and voltage-resistant protective function due to rupture. Preferably, the monofunctional acrylate monomer is a combination of the benzene ring-containing acrylate monomer, the bridge group-containing acrylate monomer and the bicyclic diene group-containing acrylate monomer, and the resulting UV glue has more excellent insulation and voltage resistance, aging resistance and mechanical properties.

In the present disclosure, the difunctional acrylate monomer is preferably at least one selected from tricyclodecane dimethanol diacrylate, 1,6-hexanediol diacrylate, dipropylene glycol diacrylate and ethoxylated bisphenol A diacrylate. The difunctional acrylate monomer can increase the density of the glue layer, improve the hardness and wear resistance of the glue layer, and effectively protect the cell from scratches during transportation and assembly. When the difunctional acrylate monomer is preferably tricyclodecane dimethanol diacrylate, due to its three-dimensional ring structure, the corresponding UV glue also has the characteristics of low shrinkage, a high glass transition temperature and aging resistance.

In the present disclosure, specific examples of the trifunctional acrylate monomer include, but are not limited to: at least one of ethoxylated trimethylolpropane triacrylate, trimethylolpropane triacrylate and tris (2-hydroxy ethyl) isocyanurate triacrylate. The trifunctional acrylate monomer uses three reactive groups as cross-linking points to connect respective acrylate oligomers and acrylate monomers, so that the system forms a dense and stable three-dimensional network structure, thereby enhancing its tensile strength, bending strength and wear resistance. When the trifunctional acrylate monomer is preferably the ethoxylated trimethylolpropane triacrylate, due to the introduction of an ethoxy group with a smaller internal rotation barrier potential, the corresponding UV glue can improve the flexibility of the macromolecules after curing, reduce the curing shrinkage, and thus improve the bonding strength. It can also improve the dispersing and wrapping of the pigment by the system, thereby increasing the storage stability of the liquid glue, thus, the glue is less likely to have problems such as sedimentation and stratification when placed at room temperature.

In the present disclosure, the acidic functional group-containing acrylate monomer is preferably a phosphate acrylate and/or a carboxylic acid group-containing acrylate. The acidic functional group-containing acrylate monomer can improve the adhesion and bonding strength of the glue layer to the aluminum layer of the cell, increase the hardness and density of the glue layer, and enhance the pressure resistance of the UV glue.

The type of the photoinitiator in the present disclosure is not particularly limited, as long as it can initiate unsaturated double bonds to achieve a free radical polymerization reaction, and it is preferably a combination of 2,4,6-trimethylbenzoyl diphenylphosphine oxide, 2-methyl-2-(4-morpholinyl)-4′-(methylthio) propiophenone and 2-isopropylthioxanthone. A mass ratio of the 2-methyl-2-(4-morpholinyl)-4′-(methylthio) propiophenone to the 2-isopropylthioxanthone is preferably (2-4): 1, e.g. 2:1, 2.5:1, 3:1, 3.5:1, 4:1 or any value therebetween; and a mass ratio of the 2,4,6-trimethylbenzoyl diphenylphosphine oxide to the 2-isopropylthioxanthone is preferably (8-18): 1, e.g. 8:1, 10:1, 12:1, 14:1, 16:1, 18:1 or any value therebetween. After in-depth study, the inventor of the present disclosure has found that the photoinitiator has light absorption ability in the ultraviolet light region (250-420 nm) and the visible light region (400-800 nm). After absorbing light energy, the initiator molecule transitions from a ground state to an excited singlet state, and then can continue to transition to an excited triplet state. At this time, the molecular has an unstable structure and will be cleaved into active free radicals, thereby initiating polymerization of the acrylate double bond. In the present disclosure, considering that the UV glue needs to adapt to a LED curing process, a 2,4,6-trimethylbenzoyl diphenylphosphine oxide (TPO) photoinitiator with an absorption wavelength up to 420 nm is selected. At the same time, the dosage is increased to increase the concentration of the photoinitiator molecules in the system, so that the outer layer of UV glue in contact with the air has a higher concentration of active free radicals when illuminated, thereby overcoming the problem of inactivation of the photoinitiator caused by cleaving into free radicals due to passivation by oxygen in the air during curing, and accelerating the surface curing and drying. Furthermore, the combination of the 2-methyl-2-(4-morpholinyl)-4′-(methylthio) propiophenone (907) and the 2-isopropylthioxanthone (ITX) is a classic photoinitiator combination suitable for colored systems. The two complement each other in the absorption band. The 2-isopropylthioxanthone photoinitiator also has a sensitizing effect, enhancing the light absorption capacity of the initiator system and reducing the effect of light absorption of a pigment on the curing of the glue layer. With the synergistic effect of the three initiators, the UV glue has extremely high curing efficiency and is no longer limited by a high-energy consumption curing process using a mercury lamp. Even when curing is conducted with a more energy-saving and efficient LED, a high degree of curing can also be achieved.

In the present disclosure, specific examples of the auxiliary agent include, but are not limited to: at least one of a pigment, a leveling agent, a dispersant, an abrasive agent and a diluent. The inventor of the present disclosure has found that when a Tego 410 type surface additive is selected as the leveling agent, it facilitates reduction of surface tension, increases surface smoothness and flatness, and can also avoid surface defects such as pinholes and unevenness. When a BYKJET-9150 type dispersant is selected, it has good compatibility with the system of the UV glue, and the active groups on the chain segments are adsorbed on the pigment through intermolecular interaction, which helps the pigment to be stably dispersed in the UV glue, improves the storage stability of the UV glue, and avoids problems such as sedimentation and stratification.

The present disclosure also provides a method for preparing a high-reliability fast-curing UV glue. The method includes uniformly mixing an acrylate oligomer, a monofunctional acrylate monomer, a difunctional acrylate monomer, a trifunctional acrylate monomer, an acidic functional group-containing acrylate monomer, a photoinitiator and an optional auxiliary agent to obtain a high-reliability fast-curing UV glue. There is no special limitation on the mixing manner, which may be to add all the raw materials at the same time and then mix them together, or to add partial of the raw materials and mix them in any order, and then add the remaining raw materials and continue mixing.

In the present disclosure, the mixing manner preferably includes the following steps:
S1. uniformly mixing a trifunctional acrylate monomer, a pigment and a dispersant to obtain a color paste premix;
S2. uniformly mixing a monofunctional acrylate monomer, a difunctional acrylate monomer, a trifunctional acrylate monomer, an acidic functional group-containing acrylate monomer, a photoinitiator and a leveling agent to obtain a pretreated material; and
S3. uniformly mixing the color paste premix obtained in S1, the pretreated material obtained in S2, and an acrylate oligomer to obtain the high-reliability fast-curing UV glue.

Moreover, the present disclosure also provides application of the high-reliability fast-curing UV glue in the insulation protection of the outer packaging of power battery cells.

The present disclosure will be further illustrated and described below in conjunction with specific examples and comparative examples. Unless otherwise specified, the parts described in the following examples and comparative examples are parts by weight.

### PREPARATION EXAMPLE 1

This preparation example provided a method for preparing a dibasic acid-modified bisphenol A epoxy acrylate

39 g of bisphenol A epoxy resin (E51), 7.41 g of acrylic acid (AA), and 7.74 g of adipic acid (Ada) were placed into a three-necked flask, and then added with 0.6 g of triphenylphosphine (PPh3) and 0.08 g of p-methoxyphenol (MEHQ). After the addition, the materials were stirred at a controlled temperature. The temperature was increased from 25° C. to 95° C. within about 3 h, maintained for 1 h, and then raised to 105° C. An acid value was tested every half an hour until the acid value reached 1 mg KOH/g, so as to obtain the dibasic acid-modified bisphenol A epoxy acrylate.

### PREPARATION EXAMPLE 2

This preparation example provided a method for preparing a dibasic acid-modified bisphenol A epoxy acrylate

39 g of bisphenol A epoxy resin (E51), 7.41 g of acrylic acid (AA), and 7.74 g of adipic acid (Ada) were placed into a three-necked flask, and then added with 0.6 g of triphenylphosphine (PPh₃) and 0.08 g of p-methoxyphenol (MEHQ). After the addition, the materials were stirred at a controlled temperature. The temperature was increased from 25°° C. to 95° C. within about 3 h, maintained for 2 h, and then raised to 115° C. An acid value was tested every half an hour until the acid value reached 0.5 mg KOH/g, so as to obtain the dibasic acid-modified bisphenol A epoxy acrylate.

### Preparation Example 3

This preparation example provided a method for preparing a dibasic acid-modified bisphenol A epoxy acrylate

39 g of bisphenol A epoxy resin (E51), 7.41 g of acrylic acid (AA), and 7.74 g of adipic acid (Ada) were placed into a three-necked flask, and then added with 0.6 g of triphenylphosphine (PPh₃) and 0.08 g of p-methoxyphenol (MEHQ). After the addition, the materials were stirred at a controlled temperature. The temperature was increased from 25° C. to 95° C. within about 3 h, maintained for 4 h, and then rose to 125° C. An acid value was tested every half an hour until the acid value reached 0.3 mg· KOH/g, so as to obtain the dibasic acid-modified bisphenol A epoxy acrylate.

### EXAMPLE 1

This example provided a method for preparing a high-reliability fast-curing UV glue.

S1. 50 parts of ethoxylated trimethylolpropane triacrylate, 50 parts of trimethylolpropane triacrylate, 5 parts of a BYKJET-9150 type dispersant and 18 parts of a blue pigment were sequentially added into a reaction kettle, and stirred at a speed of 1,000 rpm until the mixture is uniformly mixed. Then the mixture was transferred into a grinding jar, ground with 1 mm zirconium oxide beads to a particle size of ≤1 μm, and filtered to obtain a color paste premix;

S2. 10 parts of benzyl acrylate, 25 parts of isobornyl acrylate, 8 parts of dicyclopentenyl

ethoxylated acrylate, 8 parts of tricyclodecane dimethanol diacrylate, 5 parts of ethoxylated trimethylolpropane triacrylate, 1 part of an acidic functional group-containing acrylate monomer P-2M (Kyoeisha Chemical), 6.6 parts of 2,4,6-trimethylbenzoyl diphenylphosphine oxide, 1.5 parts of 2-methyl-2-(4-morpholinyl)-4′-(methylthio) propiophenone, 0.5 parts of 2-isopropylthioxanthone and 0.1 parts of a Tego 410 type leveling agent were added into a reaction kettle, and dispersed at a high speed of 500 rpm until completely dissolved to obtain a pretreated material; and

S3. the pretreated material was added with 6 parts of the color paste premix, and stirred at a speed of 500 rpm until the mixture is uniformly mixed; then the mixture was added with 15 parts of the dibasic acid-modified bisphenol A epoxy acrylate prepared in Preparation Example 1, 10 parts of a tetrafunctional branched polyester acrylate (Changxing 6320), and 6 parts of polyurethane acrylate with polyester diol as a main chain (brand name: Yinzhu Y-5656), stirred at a speed of 1,000 rpm until the mixture is uniformly mixed, and then filtered to obtain the high-reliability fast-curing UV glue.

### EXAMPLE 2

This example provided a method for preparing a high-reliability fast-curing UV glue.

S1. 50 parts of ethoxylated trimethylolpropane triacrylate, 50 parts of trimethylolpropane triacrylate, 5 parts of a BYKJET-9150 type dispersant and 18 parts of a blue pigment were sequentially added into a reaction kettle, and stirred at a speed of 1,000 rpm until the mixture is uniformly mixed. Then the mixture was transferred into a grinding jar, ground with 1 mm zirconium oxide beads to a particle size of ≤1 μm, and filtered to obtain a color paste premix;

S2. 25 parts of benzyl acrylate, 25 parts of isobornyl acrylate, 8 parts of dicyclopentenyl ethoxylated acrylate, 8 parts of tricyclodecane dimethanol diacrylate, 5 parts of ethoxylated trimethylolpropane triacrylate, 1 part of an acidic functional group-containing acrylate monomer P-2M (Kyoeisha Chemical), 6.6 parts of 2,4,6-trimethylbenzoyl diphenylphosphine oxide, 1.5 parts of 2-methyl-2-(4-morpholinyl)-4′-(methylthio) propiophenone, 0.5 parts of 2-isopropylthioxanthone and 0.1 parts of a Tego 410 type leveling agent were added into a reaction kettle, and dispersed at a high speed of 500 rpm until completely dissolved to obtain a pretreated material; and

S3. the pretreated material was added with 6 parts of the color paste premix, and stirred at a speed of 500 rpm until the mixture is uniformly mixed; then the mixture was added with 15 parts of the dibasic acid-modified bisphenol A epoxy acrylate prepared in Preparation Example 1, 10 parts of a tetrafunctional branched polyester acrylate (EBECRYL 657 available from Allnex Resins (China) Co., Ltd.), and 6 parts of polyurethane acrylate with polyester diol as a main chain (brand name: Yinzhu Y-5656), stirred at a speed of 1,000 rpm until the mixture is uniformly mixed, and then filtered to obtain the high-reliability fast-curing UV glue.

### EXAMPLE 3

This example provided a method for preparing a high-reliability fast-curing UV glue.

S1. 50 parts of ethoxylated trimethylolpropane triacrylate, 50 parts of trimethylolpropane triacrylate, 5 parts of a BYKJET-9150 type dispersant and 18 parts of a blue pigment were sequentially added into a reaction kettle, and stirred at a speed of 1,000 rpm until the mixture is uniformly mixed. Then the mixture was transferred into a grinding jar, ground with 1 mm zirconium oxide beads to a particle size of ≤1 μm, and filtered to obtain a color paste premix;

S2. 25 parts of benzyl acrylate, 25 parts of isobornyl acrylate, 8 parts of dicyclopentenyl acrylate, 8 parts of dicyclopentenyl ethoxylated acrylate, 8 parts of tricyclodecane dimethanol diacrylate, 5 parts of ethoxylated trimethylolpropane triacrylate, 1 part of an acidic functional group-containing acrylate monomer P-2M (Kyoeisha Chemical), 6.6 parts of 2,4,6-trimethylbenzoyl diphenylphosphine oxide, 1.5 parts of 2-methyl-2-(4-morpholinyl)-4′-(methylthio) propiophenone, 0.5 parts of 2-isopropylthioxanthone and 0.1 parts of a Tego 410 type leveling agent were added into a reaction kettle, and dispersed at a high speed of 500 rpm until completely dissolved to obtain a pretreated material; and

S3. the pretreated material was added with 6 parts of the color paste premix, and stirred at a speed of 500 rpm until the mixture is uniformly mixed; then the mixture was added with 15 parts of the dibasic acid-modified bisphenol A epoxy acrylate prepared in Preparation Example 1, 10 parts of a tetrafunctional branched polyester acrylate (EBECRYL 800 available from Allnex Resins (China) Co., Ltd.), and 6 parts of polyurethane acrylate with polyester diol as a main chain (brand name: Yinzhu Y-5656), stirred at a speed of 1,000 rpm until the mixture is uniformly mixed, and then filtered to obtain the high-reliability fast-curing UV glue.

### EXAMPLE 4

This example provided a method for preparing a high-reliability fast-curing UV glue.

S1. 50 parts of ethoxylated trimethylolpropane triacrylate, 50 parts of trimethylolpropane triacrylate, 5 parts of a BYKJET-9150 type dispersant and 18 parts of a blue pigment were sequentially added into a reaction kettle, and stirred at a speed of 1,000 rpm until the mixture is uniformly mixed. Then the mixture was transferred into a grinding jar, ground with 1 mm zirconium oxide beads to a particle size of ≤1 μm, and filtered to obtain a color paste premix;

S2. 25 parts of benzyl acrylate, 25 parts of isobornyl acrylate, 8 parts of dicyclopentenyl ethoxylated acrylate, 8 parts of tricyclodecane dimethanol diacrylate, 5 parts of ethoxylated trimethylolpropane triacrylate, 1 part of an acidic functional group-containing acrylate monomer P-2M (Kyoeisha Chemical), 4 parts of 2,4,6-trimethylbenzoyl diphenylphosphine oxide, 1.5 parts of 2-methyl-2-(4-morpholinyl)-4′-(methylthio) propiophenone, 0.5 parts of 2-isopropylthioxanthone and 0.1 parts of a Tego 410 type leveling agent were added into a reaction kettle, and dispersed at a high speed of 500 rpm until completely dissolved to obtain a pretreated material; and

S3. the pretreated material was added with 6 parts of the color paste premix, and stirred at a speed of 500 rpm until the mixture is uniformly mixed; then the mixture was added with 15 parts of the dibasic acid-modified bisphenol A epoxy acrylate prepared in Preparation Example 1, 10 parts of a tetrafunctional branched polyester acrylate (GU9400Y available from Qualipoly Chemical Corporation), and 6 parts of polyurethane acrylate with polyester diol as a main chain (brand name: Yinzhu Y-5656), stirred at a speed of 1,000 rpm until the mixture is uniformly mixed, and then filtered to obtain the high-reliability fast-curing UV glue.

### EXAMPLE 5

This example provided a method for preparing a high-reliability fast-curing UV glue.

S1. 100 parts of trimethylolpropane triacrylate, 5 parts of a BYKJET-9150 type dispersant and 18 parts of a blue pigment were sequentially added into a reaction kettle, and stirred at a speed of 1,000 rpm until the mixture is uniformly mixed. Then the mixture was transferred into a grinding jar, ground with 1 mm zirconium oxide beads to a particle size of ≤1 μm, and filtered to obtain a color paste premix;

S2. 58 parts of isobornyl acrylate, 8 parts of tricyclodecane dimethanol diacrylate, 5 parts of trimethylolpropane triacrylate, 1 part of an acidic functional group-containing acrylate monomer P-2M (Kyoeisha Chemical), 6.5 parts of 2,4,6-trimethylbenzoyl diphenylphosphine oxide, 2 parts of 2-methyl-2-(4-morpholinyl)-4′-(methylthio) propiophenone, 0.5 parts of 2-isopropylthioxanthone and 0.1 parts of a Tego 410 type leveling agent were added into a reaction kettle, and dispersed at a high speed of 500 rpm until completely dissolved to obtain a pretreated material; and

S3. the pretreated material was added with 6 parts of the color paste premix, and stirred at a speed of 500 rpm until the mixture is uniformly mixed; then the mixture was added with 15 parts of the dibasic acid-modified bisphenol A epoxy acrylate prepared in Preparation Example 2, 13.5 parts of a tetrafunctional branched polyester acrylate (GU9600Z available from Qualipoly Chemical Corporation), and 3 parts of polyurethane acrylate with polyester diol as a main chain (brand name: Yinzhu Y-5656), stirred at a speed of 1,000 rpm until the mixture is uniformly mixed, and then filtered to obtain the high-reliability fast-curing UV glue.

### EXAMPLE 6

This example provided a method for preparing a high-reliability fast-curing UV glue.

S1. 100 parts of tris (2-hydroxy ethyl) isocyanurate triacrylate, 5 parts of a BYKJET-9150 type dispersant and 18 parts of a blue pigment were sequentially added into a reaction kettle, and stirred at a speed of 1,000 rpm until the mixture is uniformly mixed. Then the mixture was transferred into a grinding jar, ground with 1 mm zirconium oxide beads to a particle size of ≤1 μm, and filtered to obtain a color paste premix;

S2. 58 parts of dicyclopentenyl ethoxylated acrylate, 8 parts of ethoxylated bisphenol A diacrylate, 5 parts of tris (2-hydroxy ethyl) isocyanurate triacrylate, 1 part of an acidic functional group-containing acrylate monomer P-2M (Kyoeisha Chemical), 6.6 parts of 2,4,6-trimethylbenzoyl diphenylphosphine oxide, 1.5 parts of 2-methyl-2-(4-morpholinyl)-4′-(methylthio) propiophenone, 0.5 parts of 2-isopropylthioxanthone and 0.1 parts of a Tego 410 type leveling agent were added into a reaction kettle, and dispersed at a high speed of 500 rpm until completely dissolved to obtain a pretreated material; and

S3. the pretreated material was added with 6 parts of the color paste premix, and stirred at a speed of 500 rpm until the mixture is uniformly mixed; then the mixture was added with 15 parts of the dibasic acid-modified bisphenol A epoxy acrylate prepared in Preparation Example 3, 13.5 parts of a tetrafunctional branched polyester acrylate (Changxing 6320), and 3 parts of polyurethane acrylate with polyester diol as a main chain (brand name: Yinzhu Y-5656), stirred at a speed of 1,000 rpm until the mixture is uniformly mixed, and then filtered to obtain the high-reliability fast-curing UV glue.

### COMPARATIVE EXAMPLE 1

According to Example 3 of patent CN112876949B, an ultraviolet-curing electric leakage blocking protective coating was synthesized, which included the following components in parts by weight: 20 parts of bifunctional fatty acid-modified bisphenol A epoxy acrylate, 15 parts of bifunctional polyHDI isocyanate acrylate, 15 parts of hydroxypropyl methacrylate, 15 parts of tetrahydrofuran acrylate, 10 parts of tricyclodecane dimethanol diacrylate, 15 parts of tricyclodecane dimethanol dimethyl diacrylate, 5 parts of propoxylated glycerol triacrylate, 15 parts of a pigment as a filler, 5 parts of 2-hydroxy-2-methyl-1-phenyl-1-propanone, 2.5 parts of (2,4,6-trimethylbenzoyl) diphenyl phosphine oxide, 5 parts of a silane coupling agent KH-570, 1.2 parts of a dispersant, 0.8 parts of a defoaming agent, and 1 part of a leveling agent.

### COMPARATIVE EXAMPLE 2

According to Example 4 of patent CN113881282A, a UV inkjet ink for surface protection of aluminum alloy for a power battery was synthesized, which included the following components in parts by weight: 6 parts of phenyl bis (2,4,6-trimethylbenzoyl) phosphine oxide, 15 parts of polyurethane acrylate, 8 parts of modified epoxy acrylate, 20 parts of cyclotrimethylol propane methylal acrylate, 10 parts of acryloyl morpholine, 25 parts of tetrahydrofuran acrylate, 10 parts of 2-phenoxyethyl acrylate, 20 parts of an UV color paste, 5 parts of ethyl acetate, and 2 parts of a leveling agent.

### COMPARATIVE EXAMPLE 3

A UV glue was prepared according to the method of Example 2, except that the content of the dibasic acid-modified bisphenol A epoxy acrylate prepared in Preparation Example 1 was 31 parts, the content of the tetrafunctional branched polyester acrylate (brand name Changxing 6320) was 0 part, the content of the polyurethane acrylate with polyester diol as the main chain (brand name Yinzhu Y-5656) was 0 part, and the remaining conditions remained unchanged.

### COMPARATIVE EXAMPLE 4

A UV glue was prepared according to the method of Example 2, except that the content of the dibasic acid-modified bisphenol A epoxy acrylate prepared in Preparation Example 1 was 0 part, the content of the tetrafunctional branched polyester acrylate (brand name Changxing 6320) was 31 parts, the content of the polyurethane acrylate with polyester diol as the main chain (brand name Yinzhu Y-5656) was 0 part, and the remaining conditions remained unchanged.

### COMPARATIVE EXAMPLE 5

A UV glue was prepared according to the method of Example 2, except that the content of the dibasic acid-modified bisphenol A epoxy acrylate prepared in Preparation Example 1 was 0 parts, the content of the tetrafunctional branched polyester acrylate (brand name Changxing 6320) was 0 part, the content of the polyurethane acrylate with polyester diol as the main chain (brand name Yinzhu Y-5656) was 31 parts, and the remaining conditions remained unchanged.

### COMPARATIVE EXAMPLE 6

A UV glue was prepared according to the method of Example 2, except that no monofunctional acrylate monomer was added to the system. That was, the contents of benzyl acrylate, isobornyl acrylate, and dicyclopentenyl ethoxylated acrylate were all 0 part, and the other conditions remained unchanged.

### COMPARATIVE EXAMPLE 7

A UV glue was prepared according to the method of Example 2, except that no difunctional acrylate monomer was added to the system. That was, the content of tricyclodecane dimethanol diacrylate was 0 part, and other conditions remained unchanged.

### COMPARATIVE EXAMPLE 8

A UV glue was prepared according to the method of Example 2, except that no trifunctional acrylate monomer was added to the system. That was, the contents of ethoxylated trimethylolpropane triacrylate and trimethylolpropane triacrylate were both 0 part, and the other conditions remained unchanged.

### COMPARATIVE EXAMPLE 9

A UV glue was prepared according to the method of Example 2, except that no acidic functional group-containing acrylate monomer was added to the system. That was, no acidic functional group-containing acrylate monomer P-2M (Kyoeisha Chemical) was added, and other conditions remained unchanged.

### COMPARATIVE EXAMPLE 10

A UV glue was prepared according to the method of Example 3, except that the tetrafunctional branched polyester acrylate (brand name Changxing 6320) was replaced by the dibasic acid-modified bisphenol A epoxy acrylate prepared in Preparation Example 1 in the same parts by weight, and the other conditions remained unchanged.

### TEST EXAMPLE

The above examples and comparative examples were subjected to the following comparison of test results.

(1) Viscosity test: The UV glue obtained in each example and comparative example was tested for viscosity by using a HAAKE MARS40 rotational rheometer adopting a No. 52 rotor, at a test temperature of 25° C. and a shear rate of 2 s⁻¹, so as to determine the viscosity (cps) of the UV glue. The results were shown in Table 1 for details.

(2) LED curing surface dry test: The film thickness of the UV glue obtained in each example and comparative example was controlled at 100±5 μm. Firstly, pre-curing was performed using a 395 nm LED (200 mj/cm^{2*}3 s), and then final curing was performed using a 365 nm LED (1,000 mj/cm²) for a final curing time up to 60 s. The surface curing degree was evaluated, where being completely dry to touch was judged as pass, and surface stickiness was judged as NG. The results were shown in Table 1 for details.

(3) Shear test: shear sheets were prepared, and two shear sheets were overlapped and bonded with the UV glue obtained in each example and comparative example. The thickness of the glue layer was controlled to be 0.25 mm. The sheets were cured at 80° C. for 4 hrs, cooled, subjected to a shear force test according to GBT7124/ISO4587 standard, with a test temperature of 25° C. and a tensile speed of 5 mm/min. The obtained specimens were subjected to a double 85 aging test (i.e., aged for 1,000 hours under the conditions of 85° C./85% RH, the same hereafter), and then the shear force was measured. So the shear strength (MPa) of the UV glue before and after double 85 aging are determined. The results were shown in Table 1 for details.

(4) Adhesion test: the UV glue sample obtained in each example and comparative example was subjected to an adhesion test according to a DIN EN ISO 2409 (coating-coating layer grid cutting test) method before and after the double 85 aging test. As divided according to the total peeling area at the edge and intersection of cutting lines, 5B referred to 0%, 4B referred to 0-5% (including the endpoint of 5%), 3B referred to 5-15% (excluding the endpoint of 5% but including the endpoint of 15%), 2B referred to 15-35% (excluding the endpoint of 15% but including the endpoint of 35%), 1B referred to 35-65% (excluding the endpoint of 35% but including the endpoint of 65%), 0B referred to being greater than 65%. The result was judged to be qualified when the adhesion >4B, thereby determining the adhesion of the UV glue before and after the double 85 aging. The results were shown in Table 1 for details.

(5) Bending test: the UV glue obtained in each example and comparative example was bent by 90° on an axial bar with a curvature radius of 32 mm, and the surface state of the glue layer was observed. If there was no obvious crack or damage, it was judged as pass, and if there was any crack or damage, it was judged as NG. The results were shown in Table 1 for details.

(6) Insulation resistance test: the UV glue obtained in each example and comparative example was subjected to a double 85 aging test. The samples before and after the double 85 aging were tested using a GPT-9803 voltage/insulation resistance tester with test conditions adjusted to a DC of 1,000 V for 10 s, click test and the test results were read to determine the insulation resistance (MΩ) of the UV glue. The results were shown in Table 1 for details.

(7) Voltage resistance test: the UV glue obtained in each example and comparative example was subjected to a double 85 aging test. The samples before and after the double 85 aging were tested using a GPT-9803 voltage/insulation resistance tester with test conditions adjusted to an AC of 2,230 V for 60 s/DC of 4,000 V for 60 s, click test and the test results were read. It was judged as pass if a leakage current ≤0.1 mA, and judged as NG if the leakage current >0.1 mA. The results were shown in Table 1 for details.

(8) Water-boiling resistance test: the UV glue obtained in each example and comparative example was placed in boiling water for 72 h, taken out, wiped dry and placed for 1 h, and tested for adhesion and voltage resistance. It was judged as pass if a adhesion ≥4 B and the voltage-resistant test's leakage current ≤0.1 mA, and judged as NG if the adhesion <4 B and the voltage-resistant test's leakage current >0.1 MA (any of these phenomena). The results were shown in Table 1 for details.

(9) Electrolyte resistance test: the UV glue sample obtained in each example and comparative example was added dropwise with 0.5 g of electrolyte, baked at 85° C. for 2 h, taken out, wiped dry, and placed for 1 h, and then subjected to an adhesion test, a voltage resistance test and appearance observation. It was judged as pass if the adhesion ≥4 B, the voltage-resistant test's leakage current ≤0.1 mA, and no obvious wrinkling and falling off in appearance, and judged as

NG if the adhesion <4 B, the voltage-resistant test's leakage current >0.1 mA, and there were obvious changes in appearance (any of these phenomena). The results were shown in Table 1 for details.

(10) Salt spray test: The test method referred to the salt spray requirements of GB/T31467.3. A aging test was carried out at the severe level (5) to test adhesion and voltage resistance. It was judged as pass if the adhesion ≥4 B and the voltage-resistant test's leakage current ≤0.1 mA, and judged as NG if the adhesion <4 B and the voltage-resistant test's leakage current >0.1 MA (any of these phenomena). The results were shown in Table 1 for details.

TABLE 1

| Item | | Example 1 | Example 2 | Example 3 | Example 4 | Example 5 | Example 6 |
|---|---|---|---|---|---|---|---|
| Viscosity (cps) | | 35 | 29 | 27 | 27 | 36 | 37 |
| LED curing | | Pass (surface | Pass (surface | Pass (surface | Pass (surface | Pass (surface | Pass (surface dried |
| surface dry | | dried within 20 s) | dried within 20 s) | dried within 20 s) | dried within 20 s) | dried within 40 s) | within 50 s) |
| Shear | Before aging | 17.8 | 19.2 | 18.6 | 19.1 | 16.4 | 16.9 |
| strength | After aging | 9.4 | 12.7 | 13.4 | 8.7 | 7.3 | 7.5 |
| (MPa) | | | | | | | |
| Adhesion | Before aging | 5B | 5B | 5B | 5B | 5B | 5B |
| | After aging | 4B | 5B | 5B | 4B | 4B | 5B |
| Bending test | | pass | pass | pass | pass | pass | pass |
| Insulation | Before aging | 9999 | 9999 | 9999 | 9999 | 9999 | 9999 |
| resistance | After aging | 9999 | 9999 | 9999 | 9999 | 9999 | 9999 |
| Voltage | Before aging | pass | pass | pass | pass | pass | pass |
| resistance | After aging | pass | pass | pass | pass | pass | pass |
| test | | | | | | | |

| | | | | | | |
|---|---|---|---|---|---|---|
| Water-boiling resistance | pass | pass | pass | pass | pass | pass |
| Electrolyte resistance | pass | pass | pass | pass | pass | pass |
| Salt spray resistance | pass | pass | pass | pass | pass | pass |

| | | Comparative | Comparative | Comparative | Comparative | Comparative | Comparative |
|---|---|---|---|---|---|---|---|
| Item | | Example 1 | Example 2 | Example 3 | Example 4 | Example 5 | Example 6 |
| Viscosity (cps) | | 236 | 30 | 42 | 23 | 35 | 1531 |
| LED curing surface dry | | NG | NG | NG | Pass (surface | NG | NG |
| | | | | | dried within 20 s) | | |
| Shear strength | Before aging | 12.3 | 16.7 | — | 17.4 | — | — |
| (MPa) | After aging | 7.0 | 7.1 | — | 6.6 | — | — |
| Adhesion | Before aging | 5B | 5B | 3B | 5B | 3B | 0B |
| | After aging | 4B | 5B | 0B | 5B | — | — |
| Bending test | | NG | pass | NG | pass | NG | NG |
| Insulation | Before aging | 9999 | 9999 | 9999 | 9999 | — | — |
| resistance (MΩ) | After aging | 9999 | — | — | — | — | — |
| Voltage resistance | Before aging | pass | pass | Pass | Pass | — | Pass |
| test | After aging | NG | NG | NG | NG | — | — |

| | | | | | | |
|---|---|---|---|---|---|---|
| Water-boiling resistance | NG | NG | NG | NG | — | — |
| Electrolyte resistance | NG | NG | — | NG | — | — |
| Salt spray resistance | — | NG | — | NG | — | — |

| | | Comparative | Comparative | Comparative | Comparative |
|---|---|---|---|---|---|
| Item | | Example 7 | Example 8 | Example 9 | Example 10 |
| Viscosity (cps) | | 23 | 23 | 28 | 39 |
| LED curing | | Pass (surface | Pass (surface | Pass (surface | NG |
| surface dry | | dried within 20 s) | dried within 20 s) | dried within 20 s) | |
| Shear | Before aging | 18.8 | 18.3 | 17.6 | 15.2 |
| strength (MPa) | After aging | 10.4 | 9.5 | 8.5 | 10.3 |
| Adhesion | Before aging | 5B | 5B | 0B | 3B |
| | After aging | 5B | 5B | — | 0B |
| Bending test | | pass | pass | NG | NG |
| Insulation | Before aging | 9999 | 9999 | 9999 | 9999 |
| resistance (MΩ) | After aging | 9999 | 9999 | — | — |
| Voltage | Before aging | Pass | Pass | — | pass |
| resistance test | After aging | NG | NG | — | NG |

| | | | | |
|---|---|---|---|---|
| Water-boiling resistance | NG | NG | — | NG |
| Electrolyte resistance | NG | NG | — | NG |
| Salt spray resistance | NG | NG | — | — |

From the results in Table 1, it can be seen that the high-reliability fast-curing UV glue provided by the present disclosure has low viscosity (27-37 cps) and a fast curing speed. It can adapt to more energy-saving and efficient LED curing and adapt to a high-precision inkjet process, while meeting the reliability requirements of insulation and voltage resistance, water-boiling resistance, and salt spray resistance and the bonding strength requirements. It can replace the PET blue film as the insulating protective layer of the outer packaging of power battery cells, reserving sufficient design space for lightweight batteries.

From the comparison between Example 2 and Comparative Example 1, it can be seen that the viscosity of the UV glue provided by the present disclosure is between 27-37 cps, which meets the requirements of a high-precision inkjet process, while the viscosity of Comparative Example 1 is relatively high and cannot adapt to the requirements of the inkjet process. Moreover, the UV glue provided by the present disclosure has a fast curing speed and a good surface drying effect, and can adapt to LED curing, while the LED curing effect of Comparative Example 1 is not ideal, and complete surface drying cannot be achieved even if the light energy is increased.

From the comparison between Example 2 and Comparative Example 2, it can be seen that the UV glue provided by the present disclosure has high bonding strength and its shear strength after 1,000 h of the double 85 aging test is still >10 MPa, which can meet the practical application requirements of battery cell bonding. It also has strong adhesion and will not cause problems of adhesion reduction or glue layer shedding even after long-term aging. The UV glue provided by the present disclosure has the reliability of good insulation and voltage resistance, water-boiling resistance, salt spray resistance, etc. The insulation resistance value is ≥10 G2 Ω at a DC of 1,000 V, which exceeds the instrument range, and no obvious voltage failure phenomenon occurs after double 85 aging. After the rigorous test in boiling water for 72 h, it can still maintain qualified adhesion and voltage resistance performance. After thermal aging in the electrolyte, it can still maintain consistent appearance and adhesion, and the insulation performance of it has no obvious attenuation. After salt spray aging, it can still have excellent adhesion to the aluminum layer, which can meet the actual use requirements for protection of a battery cell. However, the bonding strength of Comparative Example 2 is poor; the leakage current exceeds the standard and even the glue layer is broken down after the double 85 aging; the test reliability is poor; and the results of aging tests such as insulation and voltage resistance, water-boiling resistance, and salt spray resistance are all not ideal.

From the comparison between Example 2 and Comparative Examples 3-9, it can be seen that when the UV glue does not simultaneously contain the three prepolymers of the dibasic acid-modified bisphenol A epoxy acrylate, the tetrafunctional branched polyester acrylate and the polyurethane acrylate with polyester diol as the main chain, the monofunctional acrylate monomer, the difunctional acrylate monomer, the trifunctional acrylate monomer and the acidic functional group-containing acrylate monomer, the prepared UV glue cannot simultaneously meet the reliability requirements of insulation and voltage resistance, water-boiling resistance and salt spray resistance as well as the high bonding strength and the fast curing performance.

From the comparison between Example 3 and Comparative Example 10, it can be seen that for the UV glue provided by the present disclosure, the integrity of the glue layer can still be ensured when the glue layer is bent with a large curvature, and no cracking or falling off phenomenon occurs. When the battery cell with this UV glue as the outer wrapping layer undergoes a large deformation, the UV glue layer can still play a role of insulation protection.

In view of the above, the three prepolymers, i.e., the dibasic acid-modified bisphenol A epoxy acrylate, the tetrafunctional branched polyester acrylate and the polyurethane acrylate with polyester diol as the main chain, are compounded and used, and meanwhile a specific proportion of the monofunctional acrylate monomer, the difunctional acrylate monomer, the trifunctional acrylate monomer and the acidic functional group-containing acrylate monomer are introduced to prepare the high-reliability fast-curing UV glue, which can endow the glue layer with the good reliability of insulation and voltage resistance, water-boiling resistance, salt spray resistance, etc. as well as the high bonding strength and the quick curing properties.

Although the embodiments of the present disclosure have been shown and described above, it is to be understood that the aforementioned embodiments are illustrative and are not to be construed as limitations on the present disclosure. Changes, modifications, substitutions and variations can be made to the aforementioned embodiments within the scope of the present disclosure by those of ordinary skills in the art, without departing from the principle and spirit of the present disclosure.

What is claimed is:

1. A high-reliability fast-curing UV glue, containing an acrylate oligomer, a monofunctional acrylate monomer, a difunctional acrylate monomer, a trifunctional acrylate monomer, an acidic functional group-containing acrylate monomer, a photoinitiator and an optional auxiliary agent, wherein the acrylate oligomer simultaneously contains a dibasic acid-modified bisphenol A epoxy acrylate, a tetrafunctional branched polyester acrylate and a polyurethane acrylate with a polyester diol as a main chain.

2. The high-reliability fast-curing UV glue according to claim 1, wherein in percentage by weight, a content of the acrylate oligomer is 20-50%, a content of the monofunctional acrylate monomer is 30-55%, a content of the difunctional acrylate monomer is 5-15%, a content of the trifunctional acrylate monomer is 3-10%, a content of the acidic functional group-containing acrylate monomer is 0.5-5%, a content of the photoinitiator is 5-12% and a content of the auxiliary agent is 0.02-2%.

3. The high-reliability fast-curing UV glue according to claim 1, wherein a mass ratio of the dibasic acid-modified bisphenol A epoxy acrylate, the tetrafunctional branched polyester acrylate and the polyurethane acrylate with the polyester diol as the main chain in the acrylate oligomer is 1:(0.3-0.9): (0.2-0.6).

4. The high-reliability fast-curing UV glue according to claim 1, wherein the dibasic acid-modified bisphenol A epoxy acrylate has a structure as shown in formula (I): 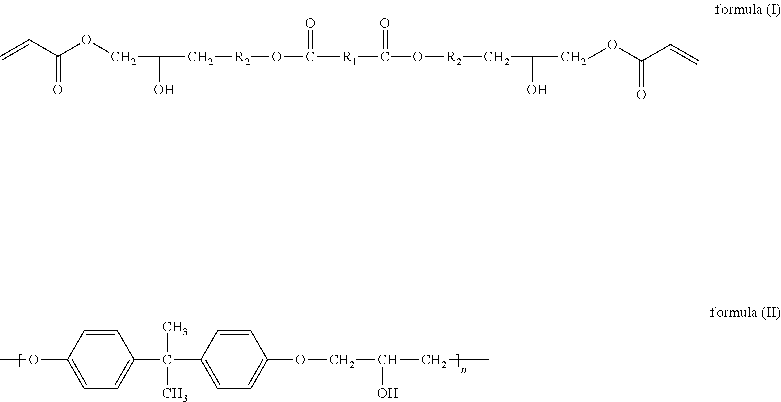
in the formula (I), R₁ is selected from one of C₁-C₁₀ alkylene groups, R₂ has a structure as shown in formula (II), and n is 1-10.

5. The high-reliability fast-curing UV glue according to claim 1, wherein the dibasic acid-modified bisphenol A epoxy acrylate is prepared according to the following method: subjecting a bisphenol A epoxy resin, acrylic acid and an aliphatic dibasic acid to a ring-opening reaction to obtain the dibasic acid-modified bisphenol A epoxy acrylate which has a structure as shown in formula (I).

6. The high-reliability fast-curing UV glue according to claim 5, wherein a general formula of the aliphatic dibasic acid is HOOC—R₁—COOH, wherein R₁ is selected from one of C₁-C₁₀ alkylene groups.

7. The high-reliability fast-curing UV glue according to claim 5, wherein a molar ratio of the bisphenol A epoxy resin to the acrylic acid is 1:(0.8-1); and a molar ratio of the bisphenol A epoxy resin to the aliphatic dibasic acid is 1:(0.35-0.55).

8. The high-reliability fast-curing UV glue according to claim 5, wherein a condition for the ring-opening reaction comprises a temperature of 90-120° C. and a time of 1-10 h.

9. The high-reliability fast-curing UV glue according to claim 1, wherein the tetrafunctional branched polyester acrylate has a main chain structure as shown in formula (III) and four acrylate functional group structures as shown in formula (III′): 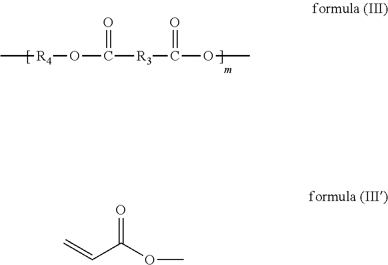
in the formula (III), R₃ and R₄ are each independently selected from one of substituted or unsubstituted C₁-C₁₀ alkylene groups, and m is 1-10.

10. The high-reliability fast-curing UV glue according to claim 1, wherein the polyurethane acrylate with the polyester diol as the main chain has a structure as shown in formula (IV): 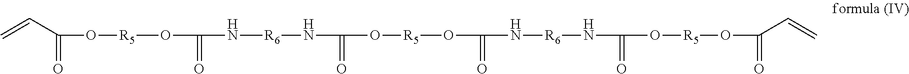
in the formula (IV), R₅ and R₆ are each independently selected from one of C₁-C₁₀ alkylene groups.

11. The high-reliability fast-curing UV glue according to claim 1, wherein the monofunctional acrylate monomer simultaneously contains a acrylate monomer containing benzene ring, a acrylate monomer containing bridge group and a acrylate monomer containing bicyclic diene group.

12. The high-reliability fast-curing UV glue according to claim 1, wherein the difunctional acrylate monomer is at least one selected from tricyclodecane dimethanol diacrylate, 1,6-hexanediol diacrylate, dipropylene glycol diacrylate and ethoxylated bisphenol A diacrylate.

13. The high-reliability fast-curing UV glue according to claim 1, wherein the trifunctional acrylate monomer is at least one selected from ethoxylated trimethylolpropane triacrylate, trimethylolpropane triacrylate and tris (2-hydroxy ethyl) isocyanurate triacrylate.

14. The high-reliability fast-curing UV glue according to claim 1, wherein the photoinitiator is a combination of 2,4,6-trimethylbenzoyl diphenylphosphine oxide, 2-methyl-2-(4-morpholinyl)-4′-(methylthio) propiophenone and 2-isopropylthioxanthone.

15. The high-reliability fast-curing UV glue according to claim 14, wherein a mass ratio of the 2-methyl-2-(4-morpholinyl)-4′-(methylthio) propiophenone to the 2-isopropylthioxanthone is (2-4):1.

16. The high-reliability fast-curing UV glue according to claim 14, wherein a mass ratio of the 2,4,6-trimethylbenzoyl diphenylphosphine oxide to the 2-isopropylthioxanthone is (8-18):1.

17. A method for preparing the high-reliability fast-curing UV glue according to claim 1, comprising uniformly mixing the acrylate oligomer, the monofunctional acrylate monomer, the difunctional acrylate monomer, the trifunctional acrylate monomer, the acidic functional group-containing acrylate monomer, the photoinitiator and the optional auxiliary agent to obtain the high-reliability fast-curing UV glue.

18. A method of using the high-reliability fast-curing UV glue according to claim 1 in insulation protection of an outer packaging of a power battery cell.
